(19) United States
(12) Patent Application Publication
(10) Pub. No.: US 2020/0281154 A1
(43) Pub. Date: Sep. 10, 2020

(54) Intelligent Self-cleaning Electric Deodorant Sand Pot for Pets

(71) Applicant: Kit Ying Gloria LI, Hong Kong (HK)

(72) Inventor: Kit Ying Gloria LI, Hong Kong (HK)

(21) Appl. No.: 16/373,594

(22) Filed: Apr. 2, 2019

(30) Foreign Application Priority Data
Mar. 4, 2019 (CN) 201910158316.6

(51) Int. Cl. A01K 1/01; A01K 1/015; A01K 29/00

(52) U.S. Cl. CPC A01K 1/011; A01K 29/005; A01K 1/0154; A01K 1/0114

(57) ABSTRACT

The invention relates to an intelligent self-cleaning electric deodorant sand pot for pets which includes a seat body, a sand pot, a sand adding device and a waste sand collecting device. The upper end of the seat body is provided with a first cavity and a second cavity. The tail end of the sand pot is embedded in the first cavity and is rotatably connected thereto. The front end of the sand pot is slidably connected with the balls. The sand pot is provided with a filter plate, a waste sand discharge port, a venting hole and a deodorizing device. The sand adding device includes a sand box fixedly arranged on the seat body, an electrically controlled valve arranged at the bottom of the sand box, a telescopic tube connecting the sand box and the sand pot. The waste sand collecting device includes a box body, and a protruding block. The box body is disposed in the second cavity and is slidably connected thereto. A gasket 43 is provided with the box body 41 and the second cavity 12 at the opening. The intelligent self-cleaning electric deodorant sand pot for pets has the advantages of simple structure, convenient structure, high intelligence degree, good deodorizing effect, and the like, and effectively solves the problem that the existing pet sand pot needs manual cleaning and sand adding.

### FIELD OF THE INVENTION

The invention relates to the technical field of intelligent household equipment, in particular to an intelligent self-cleaning electric deodorant sand pot for pets.

### BACKGROUND

As the society continues to develop, people's living standards have improved, and more and more people are starting to raise pets. But it is not only the joy and emotional comfort brought by pets, but the pet's life also brings a lot of inconvenience to the owner, such as pet diet, excretion and so on. The sand pot is used for pets and urine. The sand pot is equipped with sand piles. In the prior art, the sand pots need to be dug out with the shovel to clean the cauldrons. The smell emitted from the cat litter will also pollute the surrounding air. When the pet enters and exits the sand pot, the sand will be splashed out. It is necessary to clean the ground around the sand pot. As the sand is reduced, the owner needs to add it at any time, which is time-consuming and troublesome.

### SUMMARY OF THE INVENTION

The technical problem to be solved is to overcome the above-mentioned deficiency by providing an intelligent self-cleaning electric deodorant sand pot for pets which has the advantages of simple structure, convenient structure, high intelligence degree, good deodorizing effect, and the like, and effectively solves the problem that the existing pet sand pot needs manual cleaning and sand adding.

The technical solution of the present invention is as follows. An intelligent self-cleaning electric deodorant sand pot for pets includes a seat body, a sand pot, a sand adding device and a waste sand collecting device. The upper end of the seat body is provided with a first cavity, the lower end of the seat body is provided with a second cavity. The second cavity is provided with a controller for an integration wireless transmitting device, and through grooves communicate with each other on the partition between the first cavity and the second cavity.

The through groove is provided with a first sliding slot formed by an inward recess. The first sliding slot is slidably connected with a slider made of carbon structural steel. The upper end of the slider protrudes from the through groove. A magnet is fixedly disposed on one end of the through groove, and the other end of the through groove is folded and provided with a partition plate for isolating the odor. The two ends of the partition plate are respectively connected with the inner wall of the through groove and the slider.

The sand pot is a hollow sphere structure having an opening on the front side. The back surface of the sand pot is fixedly provided with a rotating shaft. The outer side wall surface of the front end of the sand pot is provided with a second sliding slot. The sand pot is embedded in the first cavity. The rotating shaft is rotatably connected to the wall surface of the first cavity by a bearing. The motor fixedly disposed on the wall surface of the first cavity is electrically connected to the rotating shaft. The wall surface of the first cavity is fixedly provided with a support seat. The upper end of the support seat is provided with balls and the lower end of the support seat is provided with a pressure sensor. The second sliding slot is slidably connected to the balls.

The sand pot is provided with a filter plate and a waste sand discharge port. The waste sand discharge port is provided with a bump, and the bump abuts against the slider when the sand pot rotates. The lower end of the filter plate is provided with a plurality of mesh for filtering the sand. A cavity for temporarily storing the usable sand is separated in the inner cavity of the sand pot by the filter plate. The waste sand is discharged into the through groove by the waste sand discharge port.

The top of the sand pot is provided with a venting hole, and the inner cavity of the sand pot is fixedly provided with a deodorizing device aligned with the venting hole. The deodorizing device includes an upper cover plate, and a lower cover plate. The upper cover plate and the lower cover plate are enclosed to form a cavity. The cavity is divided into a third cavity and a fourth cavity by the partition. The third cavity is filled with an odor adsorption medium, and the fourth cavity is provided with a fan for supplying air to the third cavity.

The sand adding device includes a sand box fixedly disposed on the seat body, an electrically controlled valve disposed at the bottom of the sand box, and a telescopic tube connecting the sand box and the sand pot.

The waste sand collecting device includes a box body having an upper opening for collecting waste sand, and a protruding block for facilitating pet to climb. The box body is disposed in the second cavity and is slidably connected thereto, and a gasket is provided with the box body and the second cavity at the opening.

Further, the sand pot at the opening is provided with an overhanging stencil for preventing external spattering of the sand, and the overhanging stencil is suspended on the inner wall of the sand pot.

Further, the odor adsorbing medium filled in the third cavity is wrapped by a filter or a filter cloth.

Further, the upper cover plate, the lower cover plate and the partition are made of a mesh plate.

Further, the contact surface of the upper cover plate and the sand pot is an arc structure.

Further, the sand pot is provided with an infrared proximity sensor and a temperature and humidity sensor.

Further, the electronically controlled valve includes a casing, a folding plate, a connecting rod and an electric cylinder fixedly arranged on the casing. The folding plate includes a rotating shaft and two hinge plates symmetrically hinged on the hinge shaft. The casing is provided with square stepped hole. The folding plate and the square stepped hole abut each other. The middle portion of the connecting rod and the casing are hinged to each other, and the two ends of the connecting rod are respectively hinged with the electric cylinder and the folding plate.

Further, the controller is electrically connected to the infrared proximity sensor, the temperature and humidity sensor, the motor, the electric cylinder, the pressure sensor, and the fan.

The technical effect of the present invention is to provide an intelligent self-cleaning electric deodorant sand pot for pets which includes a seat body, a sand pot, a sand adding device and a waste sand collecting device. The sand pot is rotatably mounted on the seat body. The waste sand which is no longer usable is filtered and poured into the waste sand collecting device by rotating the sand pot. The waste sand collecting device is provided with a plurality of sealing structures to prevent the odor from spreading outward, and the sand pot itself is also provided with a deodorizing device to remove the odor. The sand adding device is connected to the sand pot by the telescopic tube. The inside of the sand adding device is provided with a plurality of spare sand. With the sand reducing, a plurality of sand is added to the sand pot. The controller controls the operation of each mechanism as a whole. The intelligent self-cleaning electric deodorant sand pot for pets has the advantages of simple structure, convenient structure, high intelligence degree, good deodorizing effect, and the like, and effectively solves the problem that the existing pet sand pot needs manual cleaning and sand adding.

### BRIEF DESCRIPTION OF THE DRAWINGS

The invention is illustrated by the following figures and embodiments.

FIG. 1 shows a schematic diagram of whole structure of an intelligent self-cleaning electric deodorant sand pot for pets in accordance with an example embodiment.

FIG. 2 shows a schematic diagram of left view of an intelligent self-cleaning electric deodorant sand pot for pets in accordance with an example embodiment.

FIG. 3 shows a schematic diagram of a side cross-section of an intelligent self-cleaning electric deodorant sand pot for pets in accordance with an example embodiment.

FIG. 4 shows a schematic diagram of cross-section of a front view of an intelligent self-cleaning electric deodorant sand pot for pets in accordance with an example embodiment.

FIG. 5 shows a schematic diagram of a through groove of an intelligent self-cleaning electric deodorant sand pot for pets in accordance with an example embodiment.

FIG. 6 shows a schematic diagram of a cross-section of a through groove of an intelligent self-cleaning electric deodorant sand pot for pets in accordance with an example embodiment.

FIG. 7 shows a schematic diagram of a support seat of an intelligent self-cleaning electric deodorant sand pot for pets in accordance with an example embodiment.

FIG. 8 shows a schematic diagram of cross-section of a deodorizing device of an intelligent self-cleaning electric deodorant sand pot for pets in accordance with an example embodiment.

FIG. 9 shows a schematic diagram of cross-section of an electrically controlled valve of an intelligent self-cleaning electric deodorant sand pot for pets in accordance with an example embodiment.

FIG. 10 shows a schematic diagram of a folding plate of an intelligent self-cleaning electric deodorant sand pot for pets in accordance with an example embodiment.

FIG. 11 shows a schematic diagram of a waste sand collecting device of an intelligent self-cleaning electric deodorant sand pot for pets in accordance with an example embodiment.

The reference numbers of the figures are as follows:

1: seat body; 11: first cavity; 12: second cavity; 121: controller; 13: through groove; 131: slider; 132: magnet; 133: partition plate; 2: sand pot; 20: temperature and humidity sensor; 201: infrared proximity sensor; 21: venting hole; 22: second sliding slot; 23: overhanging stencil; 24: rotating shaft; 25: motor; 26: support seat; 261: balls; 262: pressure sensor; 27: deodorizing device; 271: upper cover plate; 272: lower cover plate; 273: partition; 274: third cavity; 275: fourth cavity; 276: fan; 28: waste sand discharging port; 281: bump; 29: filtering plate; 291: mesh; 3: sand adding device; 30: sand box; 31: electrically controlled valve; 311: casing; 312: square stepped hole; 313: folding plate; 3131: rotating shaft; 3132: hinged plate; 314: connecting rod; 315: electrical cylinder; 32: telescopic tube; 4: waste sand collecting device; 41: box body; 42: protruding block; 43: gasket.

### DETAILED DESCRIPTION

The invention is illustrated in accordance with figures. The figures as simplified diagrams demonstrate the basic structures of the apparatus of embodiments of the invention. Thus, the invention is not limited to the figures.

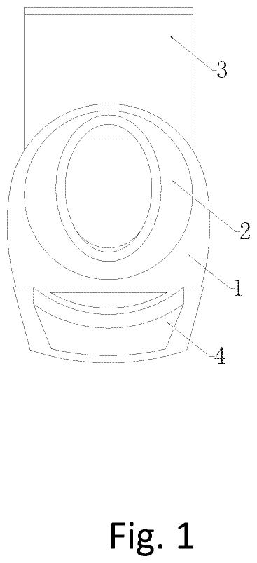

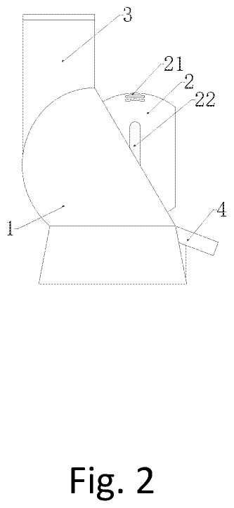

Referring to FIGS. 1-2, an intelligent self-cleaning electric deodorant sand pot for pets includes a seat body 1, a sand pot 2, a sand adding device 3 and a waste sand collecting device 4.

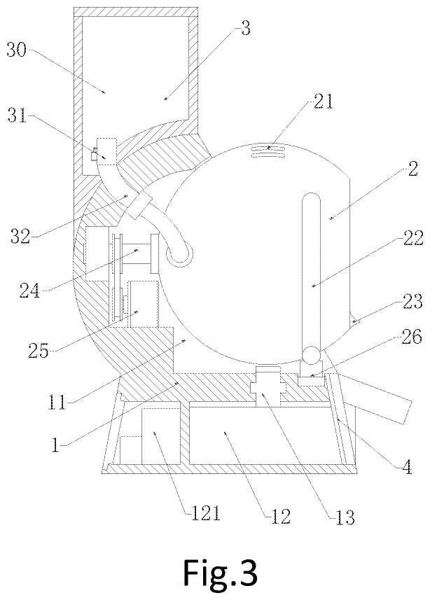

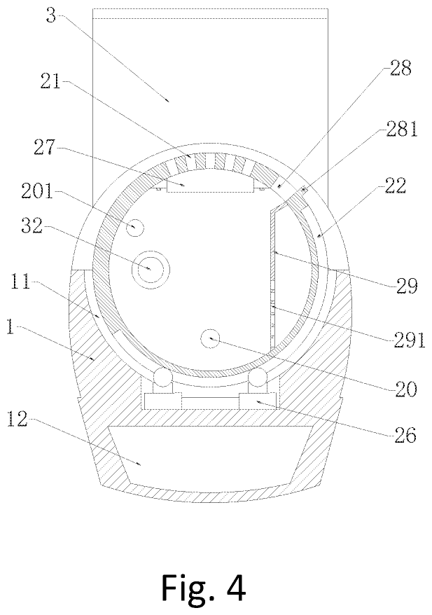

As shown in FIGS. 3 and 4, the upper end of the seat body 1 is provided with a first cavity 11, the lower end of the seat body 1 is provided with a second cavity 12. The second cavity 12 is provided with a controller for an integration wireless transmitting device 121, and through grooves 13 communicate with each other on the partition between the first cavity 11 and the second cavity 12.

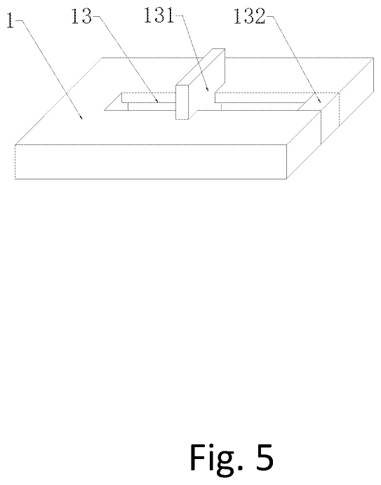

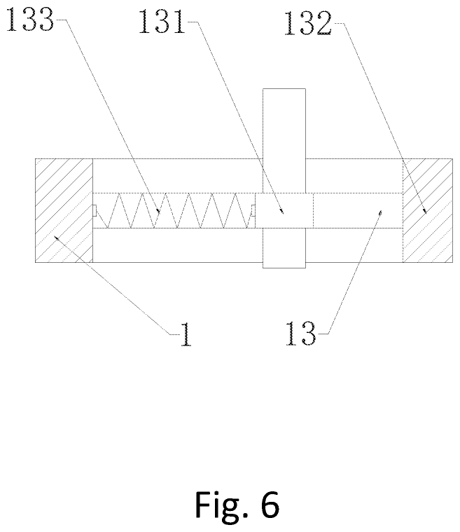

As shown in FIGS. 5 and 6, the through groove 13 is provided with a first sliding slot formed by an inward recess. The first sliding slot is slidably connected with a slider 131 made of carbon structural steel. The upper end of the slider 131 protrudes from the through groove 13. A magnet 132 is fixedly disposed on one end of the through groove 13, and the other end of the through groove 13 is folded and provided with a partition plate 133 for isolating the odor. The two ends of the partition plate 133 are respectively connected with the inner wall of the through groove 13 and the slider 131.

In an example embodiment, the partition plate 133 is made by folding flexible rubber plate or silicon plate.

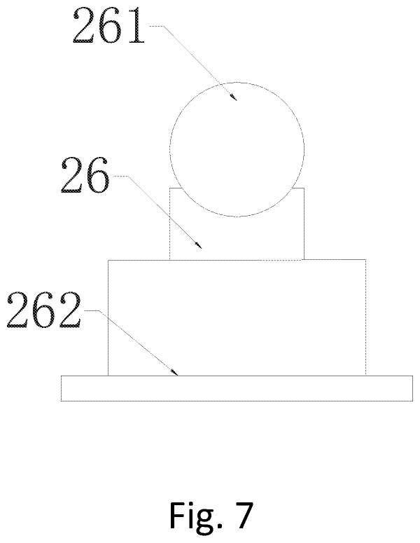

As shown in FIGS. 1, 2 and 3, the sand pot 2 is a hollow sphere structure having an opening on the front side. The back surface of the sand pot 2 is fixedly provided with a rotating shaft 24. The outer side wall surface of the front end of the sand pot 2 is provided with a second sliding slot 22. The sand pot 2 is embedded in the first cavity 11. The rotating shaft is rotatably connected to the wall surface of the first cavity 11 by a bearing. The motor 25 fixedly disposed on the wall surface of the first cavity 11 is electrically connected to the rotating shaft 24. The wall surface of the first cavity 11 is fixedly provided with a support seat 26. As shown in FIG. 7, the upper end of the support seat 26 is provided with balls 261 and the lower end of the support seat 261 is provided with a pressure sensor 262. The second sliding slot 22 is slidably connected to the balls 261. The balls 261 should be uniformly symmetrically disposed under the sand pot 2 to prevent the sand pot 2 from being displaced due to uneven force when rotating. In one example embodiment, the balls 261 can be replaced by circular arc guides, or any element that can support and rotate the sand pot 2.

The sand pot 2 is provided with a filter plate 29 and a waste sand discharge port 28. The waste sand discharge port 28 is provided with a bump 281, and the bump 281 abuts against the slider 131 when the sand pot 2 rotates. The lower end of the filter plate 29 is provided with a plurality of mesh 291 for filtering the sand. A cavity for temporarily storing the usable sand is separated in the inner cavity of the sand pot 2 by the filter plate 29. The waste sand is discharged into the through groove 13 by the waste sand discharge port 28.

The top of the sand pot 2 is provided with a venting hole 21, and the inner cavity of the sand pot 2 is fixedly provided with a deodorizing device 27 aligned with the venting hole.

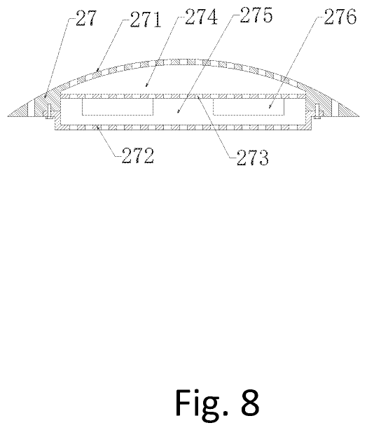

As shown in FIG. 8, the deodorizing device 27 includes an upper cover plate 271, and a lower cover plate 272. The upper cover plate 271 and the lower cover plate 272 are enclosed to form a cavity. The cavity is divided into a third cavity 274 and a fourth cavity 275 by the partition. The third cavity 274 is filled with an odor adsorption medium, and the fourth cavity 275 is provided with a fan 276 for supplying air to the third cavity 274.

The sand adding device 3 includes a sand box 30 fixedly disposed on the seat body 1, an electrically controlled valve 31 disposed at the bottom of the sand box 30, and a telescopic tube 32 connecting the sand box 30 and the sand pot 2.

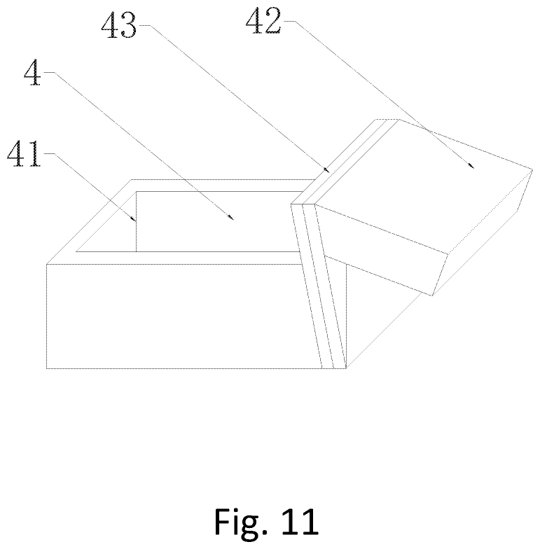

As shown in FIGS. 3 and 11, the waste sand collecting device 4 includes a box body 41 having an upper opening for collecting waste sand, and a protruding block 42 for facilitating pet to climb. The box body 41 is disposed in the second cavity 12 and is slidably connected thereto, and a gasket 43 is provided with the box body 41 and the second cavity 12 at the opening.

When the sand pot 2 rotates, the sand in the sand pot 2 is filtered by the filter plate 29, and the still usable sand particles are stored in the temporary storage cavity divided by the filter plate 29, and the unusable sand grains are discharged from the waste sand discharge port 28. The bump 281 on the waste sand discharge port opens the slider 131. The waste sand enters the waste sand collecting device 4 through the through groove 13. When the sand pot 2 is rotated and reset again, the slider 131 pulls the partition plate 133 by the gravitational force of the magnet 132 so that the through groove 13 is sealed to prevent odor from releasing outwardly. At the same time, the pressure sensor 262 detects a decrease in the amount of sand, and then the sand is added to the sand pot by opening the electronically controlled valve 31. In an example embodiment, the bottom of the inner cavity of the sand box 30 is provided with a pressure sensor for sensing the amount of sand in the sand box 30, and connected to the controller. Correspondingly, a sound and/or visual reminder connected to the controller should be provided, such as speakers, lights, etc.

In an example embodiment as shown in FIG. 3, the sand pot 2 at the opening is provided with an overhanging stencil 23 for preventing external spattering of the sand, and the overhanging stencil is suspended on the inner wall of the sand pot 2. The spattered sand is leaked from the overhanging stencil 23 and falls back into the sand pot along the inner wall of the sand pot 2.

In an example embodiment, the odor adsorbing medium filled in the third cavity 274 is wrapped by a filter or a filter cloth to prevent the odor adsorbing medium falling to contaminate the sand.

In an example embodiment as shown in FIG. 8, the upper cover plate 271, the lower cover plate 272 and the partition 273 are made of a mesh plate.

In an example embodiment as shown in FIG. 8, the contact surface of the upper cover plate 271 and the sand pot 2 is an arc structure.

In an example embodiment as shown in FIG. 4, the sand pot 2 is provided with an infrared proximity sensor 201 and a temperature and humidity sensor 20. The infrared proximity sensor 201 is configured to detect whether a pet is approaching or using a sand pot to avoid injury or shock to the pet. The temperature and humidity sensor 20 is used for detecting the temperature and humidity in the sand pot, and timely removing moisture and high temperature in the sand pot 2 to make the environment inside the sand pot 2 more comfortable.

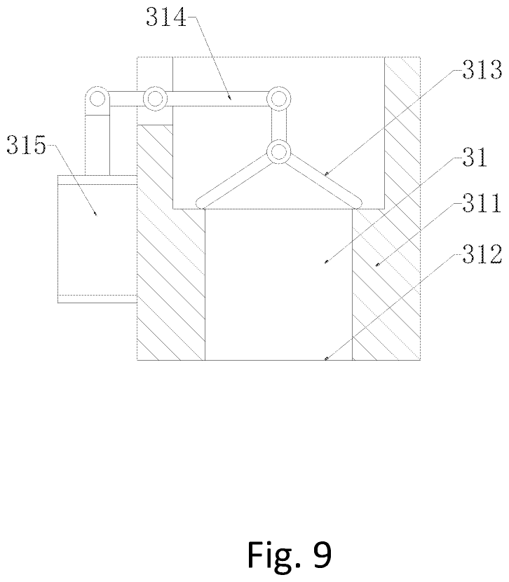

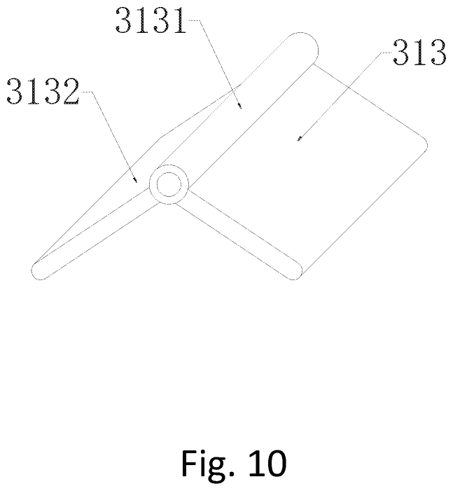

In an example embodiment as shown in FIGS. 9 and 10, the electronically controlled valve 31 includes a casing 311, a folding plate 313, a connecting rod 314 and an electric cylinder 315 fixedly arranged on the casing 311. The folding plate 313 includes a rotating shaft 313 and two hinge plates 3132 symmetrically hinged on the hinge shaft 3131. The casing 311 is provided with square stepped hole 312. The folding plate 313 and the square stepped hole 312 abut each other. The middle portion of the connecting rod 314 and the casing 311 are hinged to each other, and the two ends of the connecting rod 314 are respectively hinged with the electric cylinder 315 and the folding plate 314. When the electronically controlled valve 31 is opened, the electric cylinder 315 pulls up the folding plate 313 through the connecting rod 314, and the sand falls. When the electronically controlled valve 31 is closed, the electric cylinder lowers the folding plate 313 through the connecting rod 314, and the folding plate 313 forms self-locking under the pressure of the sand and the support of the square stepped hole 312.

In an example embodiment, the controller 121 is electrically connected to the infrared proximity sensor 201, the temperature and humidity sensor 20, the motor 25, the electric cylinder 315, the pressure sensor 262, and the fan 276. The controller 121 is connected to an external device by the wireless connecting device and the controller is connected to the external power source.

An intelligent self-cleaning electric deodorant sand pot for pets of the present invention includes a seat body, a sand pot, a sand adding device and a waste sand collecting device. The sand pot is rotatably mounted on the seat body. The waste sand which is no longer usable is filtered and poured into the waste sand collecting device by rotating the sand pot. The waste sand collecting device is provided with a plurality of sealing structures to prevent the odor from spreading outward, and the sand pot itself is also provided with a deodorizing device to remove the odor. The sand adding device is connected to the sand pot by the telescopic tube. The inside of the sand adding device is provided with a plurality of spare sand. With the sand reducing, a plurality of sand is added to the sand pot. The controller controls the operation of each mechanism as a whole. The intelligent self-cleaning electric deodorant sand pot for pets has the advantages of simple structure, convenient structure, high intelligence degree, good deodorizing effect, and the like, and effectively solves the problem that the existing pet sand pot needs manual cleaning and sand adding.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An intelligent self-cleaning electric deodorant sand pot for pets, comprising:
a seat body 1, a sand pot 2, a sand adding device 3 and a waste sand collecting device 4, wherein the upper end of the seat body 1 is provided with a first cavity 11, the lower end of the seat body 1 is provided with a second cavity 12; the second cavity 12 is provided with a controller for an integration wireless transmitting device 121, and through grooves 13 communicate with each other on the partition between the first cavity 11 and the second cavity 12,
wherein the through groove 13 is provided with a first sliding slot formed by an inward recess; the first sliding slot is slidably connected with a slider 131 made of carbon structural steel; the upper end of the slider 131 protrudes from the through groove 13; a magnet 132 is fixedly disposed on one end of the through groove 13, and the other end of the through groove 13 is folded and provided with a partition plate 133 for isolating the odor; the two ends of the partition plate 133 are respectively connected with the inner wall of the through groove 13 and the slider 131,
wherein the sand pot 2 is a hollow sphere structure having an opening on the front side; the back surface of the sand pot 2 is fixedly provided with a rotating shaft 24; the outer side wall surface of the front end of the sand pot 2 is provided with a second sliding slot 22; the sand pot 2 is embedded in the first cavity 11; the rotating shaft is rotatably connected to the wall surface of the first cavity 11 by a bearing; the motor 25 fixedly disposed on the wall surface of the first cavity 11 is electrically connected to the rotating shaft 24; the wall surface of the first cavity 11 is fixedly provided with a support seat 26; the upper end of the support seat 26 is provided with balls 261 and the lower end of the support seat 261 is provided with a pressure sensor 262; the second sliding slot 22 is slidably connected to the balls 261,
wherein the sand pot 2 is provided with a filter plate 29 and a waste sand discharge port 28; the waste sand discharge port 28 is provided with a bump 281, and the bump 281 abuts against the slider 131 when the sand pot 2 rotates; the lower end of the filter plate 29 is provided with a plurality of mesh 291 for filtering the sand; a cavity for temporarily storing the usable sand is separated in the inner cavity of the sand pot 2 by the filter plate 29; the waste sand is discharged into the through groove 13 by the waste sand discharge port 28,
wherein the top of the sand pot 2 is provided with a venting hole 21, and the inner cavity of the sand pot 2 is fixedly provided with a deodorizing device 27 aligned with the venting hole; the deodorizing device 27 includes an upper cover plate 271, and a lower cover plate 272; the upper cover plate 271 and the lower cover plate 272 are enclosed to form a cavity; the cavity is divided into a third cavity 274 and a fourth cavity 275 by the partition; the third cavity 274 is filled with an odor adsorption medium, and the fourth cavity 275 is provided with a fan 276 for supplying air to the third cavity 274,
wherein the sand adding device 3 includes a sand box 30 fixedly disposed on the seat body 1, an electrically controlled valve 31 disposed at the bottom of the sand box 30, and a telescopic tube 32 connecting the sand box 30 and the sand pot 2,
wherein the waste sand collecting device 4 includes a box body 41 having an upper opening for collecting waste sand, and a protruding block 42 for facilitating pet to climb; the box body 41 is disposed in the second cavity 12 and is slidably connected thereto, and a gasket 43 is provided with the box body 41 and the second cavity 12 at the opening.

2. The intelligent self-cleaning electric deodorant sand pot for pets of claim 1, wherein the sand pot 2 at the opening is provided with an overhanging stencil 23 for preventing external spattering of the sand, and the overhanging stencil is suspended on the inner wall of the sand pot 2.

3. The intelligent self-cleaning electric deodorant sand pot for pets of claim 1, wherein the odor adsorbing medium filled in the third cavity 274 is wrapped by a filter or a filter cloth.

4. The intelligent self-cleaning electric deodorant sand pot for pets of claim 1, wherein the upper cover plate 271, the lower cover plate 272 and the partition 273 are made of a mesh plate.

5. The intelligent self-cleaning electric deodorant sand pot for pets of claim 1, wherein the contact surface of the upper cover plate 271 and the sand pot 2 is an arc structure.

6. The intelligent self-cleaning electric deodorant sand pot for pets of claim 1, wherein the sand pot 2 is provided with an infrared proximity sensor 201 and a temperature and humidity sensor 20.

7. The intelligent self-cleaning electric deodorant sand pot for pets of claim 1, wherein the electronically controlled valve 31 includes a casing 311, a folding plate 313, a connecting rod 314 and an electric cylinder 315 fixedly arranged on the casing 311; the folding plate 313 includes a rotating shaft 313 and two hinge plates 3132 symmetrically hinged on the hinge shaft 3131; the casing 311 is provided with square stepped hole 312; the folding plate 313 and the square stepped hole 312 abut each other; the middle portion of the connecting rod 314 and the casing 311 are hinged to each other, and the two ends of the connecting rod 314 are respectively hinged with the electric cylinder 315 and the folding plate 314.

8. The intelligent self-cleaning electric deodorant sand pot for pets of claim 1, wherein, the controller 121 is electrically connected to the infrared proximity sensor 201, the temperature and humidity sensor 20, the motor 25, the electric cylinder 315, the pressure sensor 262, and the fan 276.

9. The intelligent self-cleaning electric deodorant sand pot for pets of claim 6, wherein, the controller 121 is electrically connected to the infrared proximity sensor 201, the temperature and humidity sensor 20, the motor 25, the electric cylinder 315, the pressure sensor 262, and the fan 276.

10. The intelligent self-cleaning electric deodorant sand pot for pets of claim 7, wherein, the controller 121 is electrically connected to the infrared proximity sensor 201, the temperature and humidity sensor 20, the motor 25, the electric cylinder 315, the pressure sensor 262, and the fan 276.
